(19) United States
(12) Patent Application Publication
(10) Pub. No.: US 2019/0172440 A1
(43) Pub. Date: Jun. 6, 2019

(54) Noise-Canceling Headphone

(71) Applicant: Foster Electric Company, Limited, Tokyo (JP)

(72) Inventor: Shinya Ashizawa, Tokyo (JP)

(73) Assignee: Foster Electric Company, Limited, Tokyo (JP)

(21) Appl. No.: 16/306,258

(22) PCT Filed: Jun. 1, 2016
(86) PCT No.: PCT/JP2016/066242

§ 371 Date: Nov. 30, 2018

(51) Int. Cl. G10K 11/178; H04R 1/02; H04R 3/00; H04R 1/10

(52) U.S. Cl. CPC G10K 11/17857; H04R 1/02; H04R 3/005; G10K 2210/3027; G10K 2210/1081; G10K 2210/3026; H04R 1/1083

(57) ABSTRACT

The noise-canceling headphone includes a housing including a microphone collecting external noise and a speaker emitting a sound toward an opening of an external auditory canal of a user. The noise-canceling headphone generates a noise-canceling signal from a noise signal collected by the microphone, drives the speaker with the noise-canceling signal, and emits a noise-canceling sound having a phase opposite to that of the external noise. One microphone is provided outside a back cavity that is an acoustic space behind a diaphragm of the speaker in a housing, and a guide guiding the external noise to the microphone is provided in the housing.

### TECHNICAL FIELD

The present disclosure relates to a noise-canceling headphone that generates a noise-canceling signal from an external noise signal generated by a microphone provided in a housing and drives a headphone unit in the housing by the noise-canceling signal to emit a canceling sound.

### BACKGROUND ART

Noise-canceling headphones (headphones with an active noise-canceling function) are constantly in demand on the market as tools that can reduce unpleasant noise in airplanes and in daily life to allow a user to feel comfortable even in spaces with noise. The mechanism thereof is as follows. Specifically, a microphone mounted on a housing of the headphone generates a noise signal, a circuit generates a “noise-canceling signal” having a phase opposite to that of noise that a user hears, and a speaker of the headphone outputs the noise-canceling signal.

The noise is canceled or reduced, and cannot be heard by the user, because sound is characterized by being canceled by adding a signal having a phase opposite to that of the sound.

An active noise-canceling system includes a “feedback system”, a “feedforward system”, and a “hybrid system” as a combination of these systems.

A microphone of the “feedback system” is provided in a space in which a speaker and a user's ear are located and picks up external noise that has entered the space.

There is therefore less difference between a sound heard with the ear and a sound input to the microphone, and a filter (a circuit generating the noise-canceling signal having the opposite phase) is easy to produce.

The microphone, however, picks up a reproduced sound from the speaker in addition to the noise, and the filter therefore needs to be devised to separate the reproduced sound from the noise. Since the microphone picks up the reproduced sound from the speaker in addition to the noise, howling can therefore occur when positive feedback of the sound becomes active and acts to amplify the reproduced sound.

On the other hand, a microphone of the “feedforward system” is not provided in the space in which the speaker and the user's ear are located but provided outside the housing of the headphone, and picks up noise outside the housing. The microphone therefore hardly picks up the reproduced sound from the speaker, does not need to separate the reproduced sound from the noise, and hardly causes howling, which occurs when the positive feedback of the sound becomes active and acts to amplify the reproduced sound.

There is, however, a difference between a sound heard with the ear and a sound input to the microphone, and a complicated filter (a circuit generating the noise-canceling signal having the opposite phase) needs to be produced.

In general, the microphone of the feedforward system is installed at one place outside the housing. There is therefore a path length difference between the length of a path from a noise generation source to the user's eardrum and the length of a path from the noise generation source to the user's eardrum through the microphone and the speaker.

This will be described with reference to FIG. 15. A speaker 3 is provided on a baffle 2a near the bottom of a housing 2 of a headphone 1. The baffle 2a partitions an acoustic space into spaces located in front of and behind a diaphragm of the speaker 3, and a back cavity 2b is formed behind the diaphragm of the speaker 3.

An eardrum 4b is located at the inner end of an external auditory canal 4a of a user 4. An ear pad 5 that is in close contact with the periphery of an opening of the external auditory canal 4a of the user 4 is provided near the bottom of the housing 2 of the headphone 1.

The speaker 3 of the headphone 1 is arranged so as to output sounds into a space surrounded by the ear pad 5 and the baffle 2a of the housing 2.

A microphone 6 of the feedforward system that picks up noise outside the housing 2 is provided outside (on the outer surface of) the housing 2 of the headphone 1. The microphone 6 in FIG. 15 is arranged in a central portion of the cross section of the housing 2 in the direction orthogonal to the traveling direction (indicated by an arrow S in FIG. 15) of the sound that is emitted from the speaker 3. A filter (not illustrated) generates a noise-canceling signal having a phase opposite to that of the noise picked up by the microphone 6, and the speaker 3 outputs a noise-canceling sound.

A reference numeral 7 indicates an upper noise generation source located above the user 4, and a reference numeral 8 indicates a lateral noise generation source located at a lateral side of the user 4. Noise from the upper noise generation source 7 is hereinafter referred to as upper emission noise, and noise from the lateral noise generation source 8 is hereinafter referred to as lateral emission noise.

As for the upper emission noise, a difference in length between a path (hereinafter, referred to as the “noise path”) through which the noise directly reaches the eardrum 4b of the user 4 without passing through the microphone 6 and the speaker 3 and a path (hereinafter, referred to as the “noise-canceling sound path”) through which the noise reaches the eardrum 4b of the user 4 through the microphone 6 and the speaker 3 is d−(a+d).

As for the lateral emission noise, the difference in length between the noise path and the noise-canceling sound path is c−a.

The path length difference thus varies between the directions of the noise generation sources. This prevents a filter from generating a proper “noise-canceling signal.” That is to say, active noise-canceling performance varies between the directions (positions) of the noise generation sources, and has directivity.

In order to reduce the difference in active noise-canceling performance between the directions of the noise generation sources, providing a plurality of microphones, such as microphones 9 and 10, in addition to the microphone 6, in the drawing has been proposed to solve the problem of the path length difference (problem of the directivity) between the directions of the noise generation sources (for example, see Patent Document 1).

### CITATION LIST

### Patent Document

PATENT DOCUMENT 1: Japanese Unexamined Patent Publication No. 2009-535655.

### SUMMARY OF THE INVENTION

### Technical Problem

A noise-canceling headphone as according to an invention of Patent Document 1 has the following problems.

1. The microphones are required, and cost is increased.

2. The path length difference (d−(a+d)) is generated for the upper emission noise, and the path length difference (c−a) is generated for the lateral emission noise. In particular, the path length difference (c−a) for the lateral emission noise is large, and a complicated filter is required to address the large path length difference.

In view of the foregoing background, it is therefore an object of the present invention to provide a noise-canceling headphone requiring no complicated filter at low cost.

### Solution to the Problem

In order to solve at least one of the problems, a noise-canceling headphone according to an aspect of the present disclosure includes a housing including a microphone collecting external noise and a speaker emitting a sound toward an opening of an external auditory canal of a user. The noise-canceling headphone generates a noise-canceling signal from a noise signal collected by the microphone, drives the speaker with the noise-canceling signal, and emits a noise-canceling sound having a phase opposite to that of the external noise. One microphone is provided outside a back cavity that is an acoustic space behind a diaphragm of the speaker in the housing and a guide guiding the external noise to the microphone is provided in the housing.

Other features of the present disclosure will become further apparent from the following description of embodiments and the accompanying drawings.

### Advantages of the Invention

According to the present disclosure, the one microphone is provided outside the back cavity that is the acoustic space behind the diaphragm of the speaker in the housing, and cost is thereby reduced.

The guide guiding the external noise to the microphone is provided in the housing and the guide is appropriately set such that a difference between a path length from a noise generation source to an eardrum of a user and a path length from the noise generation source to the eardrum of the user through the microphone and the speaker is small and the path length difference does not significantly vary depending on the direction of the noise generation source. Accordingly, the phase difference resulting from the phase length difference and the wavelength of the noise can be reduced.

The noise-canceling headphone generates the noise-canceling signal by advancing and delaying a phase of a microphone signal through a circuit. The reduction in the phase difference can eliminate the need for a complicated filter, and the noises from the associated directions can be canceled to the same degree even if the noises have a higher frequency.

Other advantages of the present disclosure will become further apparent from the following description of embodiments and the accompanying drawings.

### BRIEF DESCRIPTION OF THE DRAWINGS

FIG. 1 illustrates a feature of a first embodiment.

FIG. 2 illustrates a feature of a second embodiment.

FIG. 3 illustrates a feature of a third embodiment.

FIG. 4 is a cross-sectional view taken along line IV-IV in FIG. 3.

FIG. 5 illustrates a feature of a fourth embodiment.

FIG. 6 is a cross-sectional view taken along line VI-VI in FIG. 5.

FIG. 7 is a perspective view of an inner housing and a guide in FIG. 5.

FIG. 8 is a table showing the lengths of paths (a to h) obtained when the diameter of a housing is changed.

FIG. 9 is a table showing path length differences for lateral emission and upper emission at respective microphone positions (1) to (6) when the diameter of the housing is set to 30 mm.

FIG. 10 is a table for explaining frequency-by-frequency phase differences resulting from the path length differences.

FIG. 11(A) is a graph showing results (phase characteristics for respective emission directions) of measurement of how signals that a microphone picks up vary with reference to noise reaching an eardrum if the noise is emitted from different directions and four ports illustrated in FIG. 3 in the present disclosure are provided.

FIG. 11(B) is a graph illustrating results (phase characteristics for respective emission directions) of measurement of how signals that the microphone picks up vary with reference to noise reaching the eardrum if the noise is emitted from different directions and in a configuration with the four ports shown in FIG. 3, the microphone is installed at a position (1) in FIG. 15 in a known example.

FIG. 12(A) is a graph showing results (phase characteristics for respective emission directions) of measurement of how signals that the microphone picks up vary with reference to noise reaching the eardrum if the noise is emitted from different directions and the microphone is omnidirectionally open as illustrated in FIG. 1 in the present disclosure.

FIG. 12(B) is a graph illustrating the results (phase characteristics for the respective emission directions) of the measurement of how the signals that the microphone picks up vary with reference to the noise reaching the eardrum if the noise is emitted from different directions and the microphone is installed at the position (1) in FIG. 15 in the known example.

FIG. 13 is a graph showing the level difference of the microphone installed in the four ports illustrated in FIGS. 3 and 5 relative to the microphone installed outside the housing illustrated in FIG. 15 in the known example.

FIG. 14 is a graph showing the level difference of the microphone installed in a slit having an opening circumferentially formed on the entire perimeter of the side surface of the housing 12 illustrated in FIG. 1 relative to the microphone installed outside the housing illustrated in FIG. 15 in the known example.

FIG. 15 illustrates a feature of a known noise-canceling headphone.

### DESCRIPTION OF EMBODIMENTS

### First Embodiment

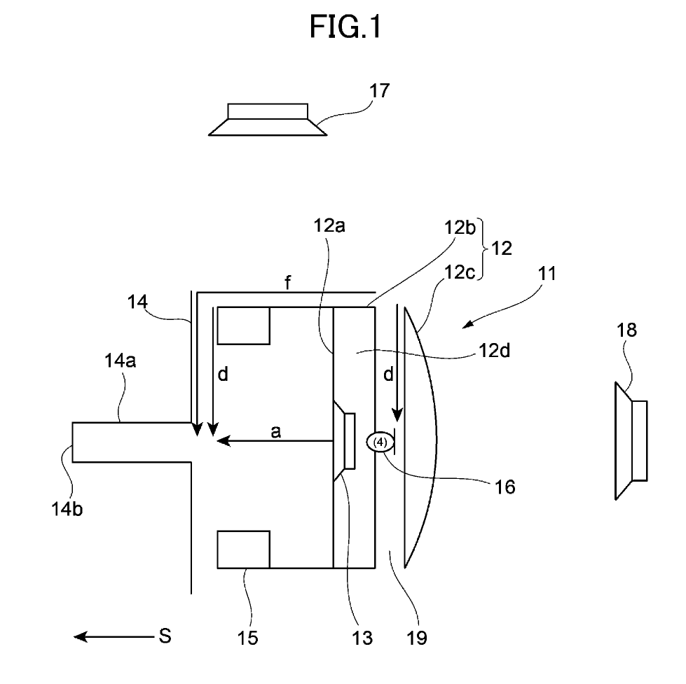

FIG. 1 illustrates a feature of a first embodiment of the present invention. In FIG. 1, a housing 12 of a headphone 11 includes an inner housing 12b having a bottomed cylindrical shape having an opening near a user 14 and a cover 12c covering the surface (bottom surface) of the inner housing 12b facing away from the user 14. A speaker 13 is provided on a baffle 12a provided at an open side of the inner housing 12b. The baffle 12a partitions an acoustic space into spaces located in front of and behind a diaphragm of the speaker 13, and a back cavity 12d forming the acoustic space behind the diaphragm is formed behind the diaphragm of the speaker 13 (a space in the inner housing 12b).

An eardrum 14b is located at the inner end of an external auditory canal 14a of the user 14. An ear pad 15 that is in close contact with the periphery of an opening of the external auditory canal 4a of the user 4 is provided near the bottom of the housing 12 of the headphone 11.

The speaker 13 of the headphone 11 is arranged so as to output sounds into a space surrounded by the ear pad 15 and the baffle 12a of the housing 12.

A microphone 16 of a feedforward system that picks up noise outside the housing 12 is provided outside the back cavity 12d (inner housing 12b) in the housing 12 of the headphone 11. The microphone 16 in FIG. 1 is arranged in a central portion of the cross section of the housing 12 in the direction orthogonal to the traveling direction (indicated by an arrow S in the drawing) of the sound that is emitted from the speaker 13. A filter (not illustrated) generates a noise-canceling signal having a phase opposite to that of the noise that the microphone 16 picks up, and a noise-canceling sound is output from the speaker 13.

A guide guiding the external noise to the microphone 16 is provided in the housing 12.

The guide in the embodiment is a slit 19 formed between the inner housing 12b and the cap 12c, that is, the slit 19 circumferentially formed on the entire perimeter of the side surface of the housing 12 extending along the traveling direction (direction indicated by the arrow S in the drawing) of the sound that is emitted from the speaker 16.

That is to say, the slit 19 has an opening circumferentially extending along the entire perimeter of the side surface of the housing 12. It should be noted that the above-mentioned configuration is also referred to as an omnidirectional open configuration.

A reference numeral 17 indicates an upper noise generation source located above the user 14 and a reference numeral 18 indicates a lateral noise generation source located at a lateral side of the user 14.

The above-mentioned configuration provides the following advantages.

1. One microphone 16 is provided outside the back cavity 12d in the housing 12, and cost is thereby reduced.

2. The slit 19 as the guide guiding the external noise to the microphone 16 is provided in the housing 12, and the slit 19 is appropriately set such that the difference between the path length from each of noise generation sources to the eardrum 14b of the user 14 and the path length from the noise generation source to the eardrum of the user through the microphone 16 and the speaker 13 is small and the path length difference does not significantly vary between the directions of the noise generation sources. Accordingly, a complicated filter is not required, and the noises from the associated directions can be canceled to the same degree even if the noises have a higher frequency.

The above-mentioned advantage that “the noises from the associated directions can be canceled to the same degree even if the noises have a higher frequency” will be described later.

### Second Embodiment

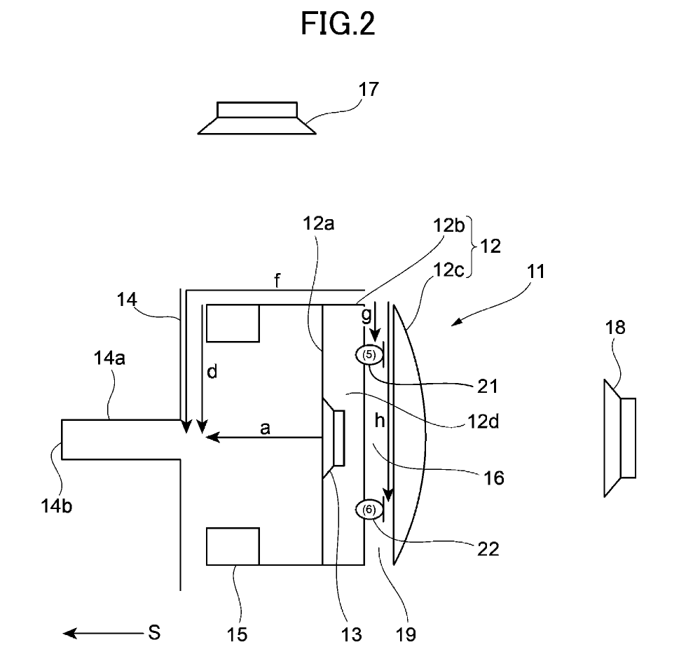

FIG. 2 illustrates a feature of a second embodiment of the present invention. The embodiment is different from the first embodiment in the position of a microphone, and is otherwise the same thereas. Like reference numerals have been used to designate identical or equivalent elements, and explanation thereof is not repeated.

The microphone in the first embodiment is arranged in a central portion of the cross section of the housing in the direction orthogonal to the traveling direction of the sound that is emitted from the speaker 13.

On the other hand, in the embodiment, a microphone 21 is provided at a position offset toward the upper noise generation source 17 from the central portion of the cross section of the housing 12 in the direction orthogonal to the traveling direction (indicated by an arrow S in the drawing) of the sound that is emitted from the speaker 13.

In another embodiment, a microphone 22 is provided at a position offset, in the direction away from the upper noise generation source 17, from the central portion of the cross section of the housing 12 in the direction orthogonal to the traveling direction (indicated by the arrow S in the drawing) of the sound that is emitted from the speaker 13.

The above-mentioned configuration provides the following advantages.

1. One microphone 21 (or one microphone 22) is provided outside the back cavity 12d in the housing 12, and cost is thereby reduced.

2. The slit 19 as a guide guiding an external noise to the microphone 21 (or the microphone 22) is provided in the housing 12, and the slit 19 is appropriately set such that the difference between the path length from each of noise generation sources to the eardrum 14b of the user 14 and the path length from the noise generation source to the eardrum of the user through the microphone 16 and the speaker 13 is small and the path length difference does not significantly vary between the directions of the noise generation sources. Accordingly, a complicated filter is not required, and the noises from the associated directions can be canceled to the same degree even if the noises have a higher frequency.

3. The microphone 21 (or the microphone 22) is provided at the position offset from the center portion of the cross section of the housing 12 in the direction orthogonal to the traveling direction (indicated by the arrow S in the drawing) of the sound that is emitted from the speaker 13. Accordingly, a degree of freedom in mechanism design can be provided.

### Third Embodiment

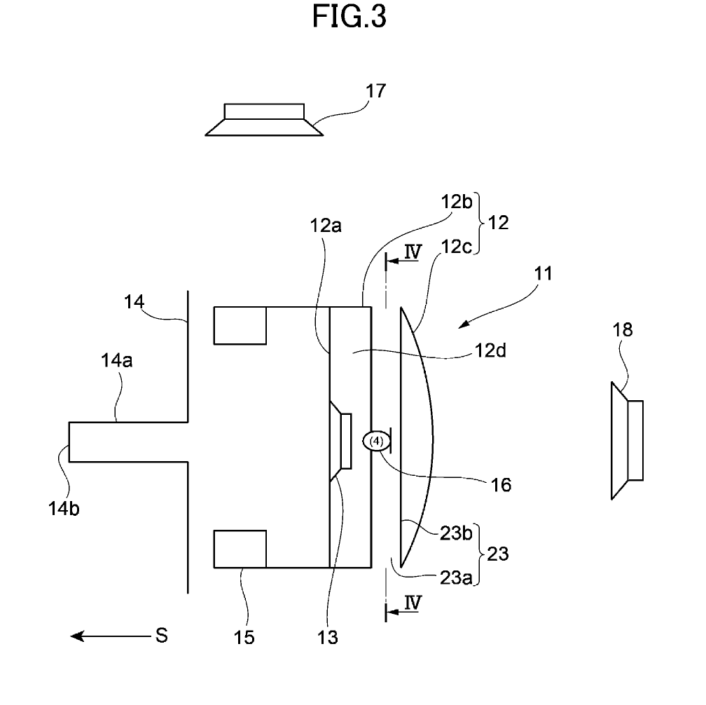

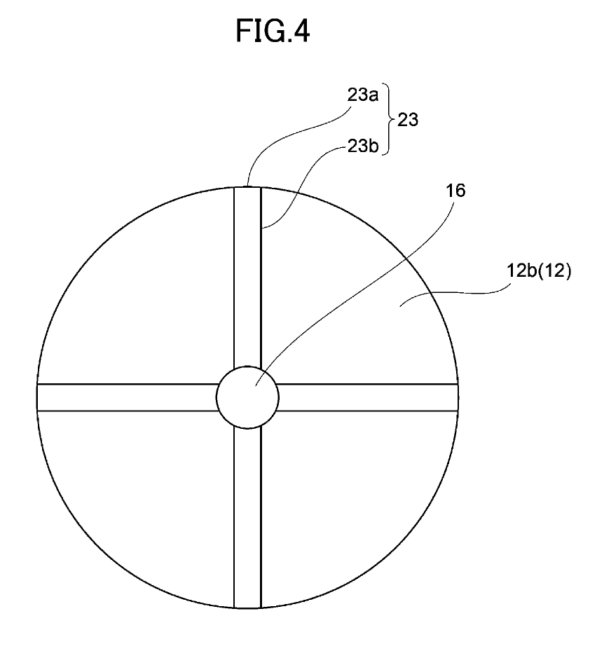

A third embodiment of the present invention will be described with reference to FIGS. 3 and 4. FIG. 3 illustrates a feature of the third embodiment of the present invention, and FIG. 4 is a cross-sectional view taken along line IV-IV in FIG. 3. This embodiment is different from the first embodiment in a guide, and is otherwise the same thereas. Like reference numerals have been used to designate identical or equivalent elements, and explanation thereof is not repeated.

A guide 23 in the embodiment includes a plurality of (four in the embodiment) sound collection holes 23a formed in the side surface (cover) of the housing 12 along the traveling direction of a sound that is emitted from the speaker 13, and tubes 23b guiding external noise from the respective sound collection holes 23a to the microphone 16. The four tubes 23b are also referred to as four ports.

The above-mentioned configuration provides the following advantages.

1. One microphone 16 is provided outside the back cavity 12d in the housing 12, and cost is thereby reduced.

2. The guide 23 guiding the external noise to the microphone 16 is provided in the housing 12, and the slit 19 is appropriately set such that the difference between the path length from each of noise generation sources to the eardrum 14b of the user 14 and the path length from the noise generation source to the eardrum of the user through the microphone 16 and the speaker 13 is small and the path length difference does not significantly vary between the directions of the noise generation sources. Accordingly, a complicated filter is not required, and the noises from the associated directions can be canceled to the same degree even if the noises have a higher frequency.

### Fourth Embodiment

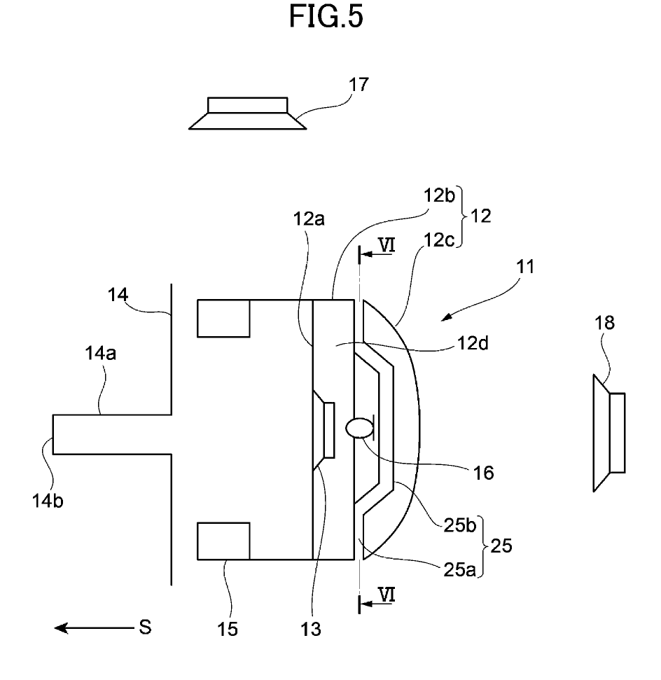

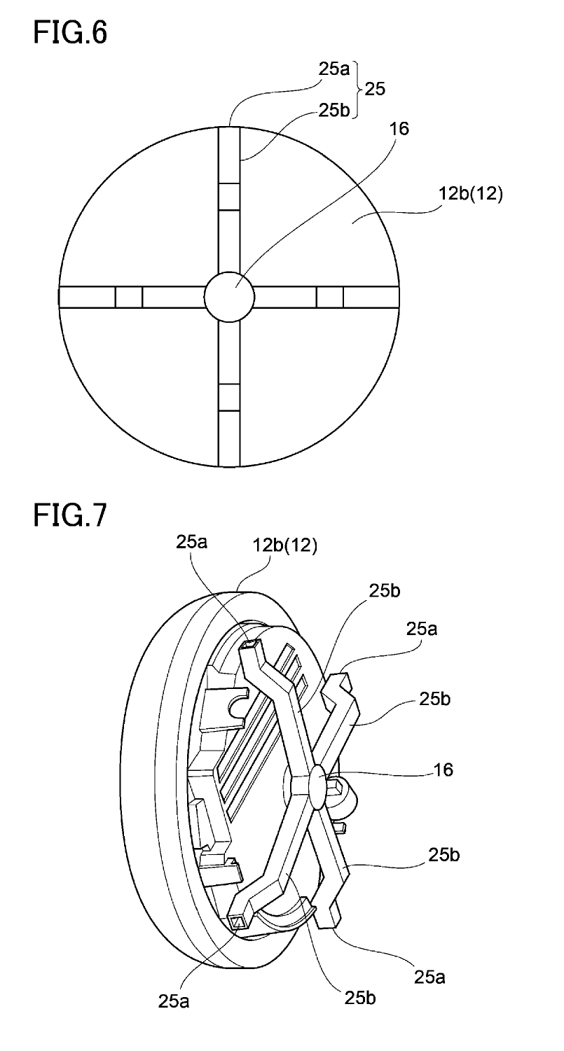

A fourth embodiment of the present invention will be described with reference to FIGS. 5 to 7. FIG. 5 illustrates a feature of the fourth embodiment of the present invention, FIG. 6 is a cross-sectional view taken along line VI-VI of FIG. 5, and FIG. 7 is a perspective view of an inner housing and a guide in FIG. 5. This embodiment is different from the third embodiment in a guide, and is otherwise the same thereas. Like reference numerals have been used to designate identical or equivalent elements, and explanation thereof is not repeated.

A guide 25 in this embodiment includes a plurality of (four in the embodiment) sound collection holes 25a formed in the side surface (cover) of the housing 12 along the traveling direction of a sound that is emitted from the speaker 13, and tubes 25b guiding external noise from the respective sound collection holes 25a to the microphone 16 just like the guide 23 in the third embodiment.

As illustrated in FIGS. 6 and 7, the tubes 25b are bent somewhere to increase the distances from the sound collection holes 25a to the microphone 16.

The above-mentioned configuration provides the following advantages.

1. One microphone 16 is provided outside the back cavity 12d in the housing 12, and cost is thereby reduced.

2. The guide 25 guiding the external noise to the microphone 13 is provided in the housing 12, and the guide 25 is appropriately set such that the difference between the path length from each of noise generation sources to the eardrum 14b of the user 14 and the path length from the noise generation source to the eardrum of the user through the microphone 16 and the speaker 13 is small and the path length difference does not significantly vary between the directions of the noise generation sources. Accordingly, a complicated filter is not required, and the noises from the associated directions can be canceled to the same degree even if the noises have a higher frequency.

It should be noted that the present invention is not limited to the above-mentioned embodiments. In each of the embodiments, for example, an over-ear headphone including ear pads 15 containing the auricles of the user, respectively, has been described.

Alternatively, the invention is applicable to an on-ear headphone.

### Examples

1.

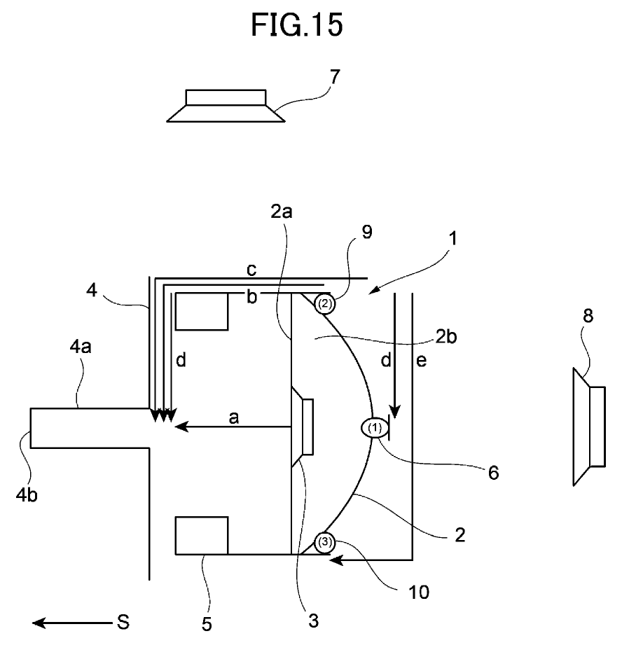

A comparison is made between the path lengths in the known noise-canceling headphone illustrated in FIG. 15 and the path lengths in the noise-canceling headphone of the present invention illustrated in FIGS. 1 and 2.

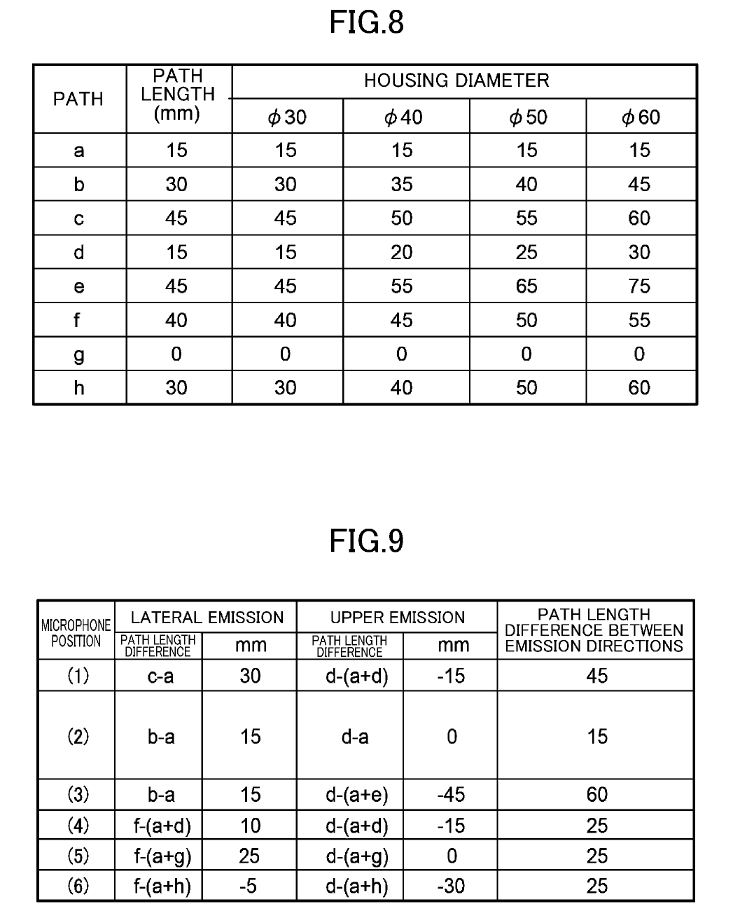

FIG. 8 shows the lengths of paths (a to h) obtained when the diameter of the housing is changed.

FIG. 9 shows path length differences for the lateral emission and the upper emission at microphone positions (1) to (6) when the diameter of the housing is set to 30 mm.

The above-mentioned calculation results are represented by the following formulae.

The path length difference between the emission directions at the microphone position (1)

$$c - a - \{ d - ( a + d ) \} = c = the radius of the ear pad + the distance from the contact surface between the ear pad and the human body to the microphone ( top of the housing )$$

The path length difference between the emission directions at the microphone position (2)

$$b - a - ( d - a ) = b - d = the distance from the contact surface between the ear pad and the human body to the microphone$$

The path length difference between the emission directions at the microphone position (3)

$$b - a - \{ d - ( a + e ) \} = b - d + e = the diameter of the ear pad + the distance from the contact surface between the ear pad and human body to the microphone ( top of the housing )$$

The path length difference between the emission directions at the microphone position (4)

$$f - ( a + d ) - \{ d - ( a + d ) \} = f - d = the distance from the contact surface between the human body and the ear pad to the microphone ( slightly longer than that at the above \text{-} mentioned positions ( 1 ) to ( 3 ) \text{:} 10 mm at the above \text{-} mentioned positions )$$

The path length differences at the microphone positions (1) and (3) are larger than that at the microphone position (4) by the radius of the ear pad or larger.

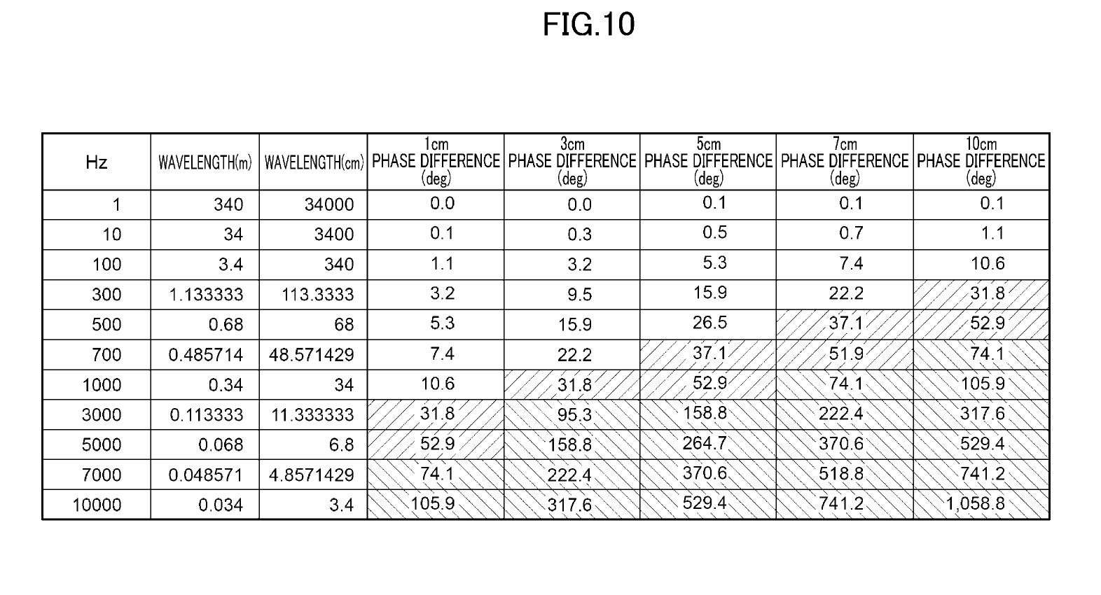

FIG. 10 reveals phase differences (deg) resulting from the path length differences. The advantage is provided when the diameter of the ear pad is equal to or larger than 2 cm. This is because the attenuation factor of amplitude is reduced by one-half at a frequency of about 3 kHz or lower even if the path length difference is 1 cm.

The path length difference at the microphone position (2) is smaller than that at the microphone position (4). However, when the lateral noise emission direction shifts by 180 degrees, the path length difference at the microphone position (2) becomes largest among the path length differences of the product, i.e., the same as that at the microphone position (3). Thus, the noise-canceling effect varies depending on the noise emission directions. This shows that the microphone position (4) is highly likely to provide a more stable effect.

When the microphone position is offset from the central portion just like a combination of the microphone positions (5) or (6), the following formulae are satisfied:

$$f - ( a + g ) - ( d - ( a + h ) ) = f - g - d + h = h - g + f - d = the diameter ( h - g ) of the ear pad at maximum + the distance from the contact surface between the ear and the human body to the mic ( f \text{-} d , slightly longer than those at the above \text{-} mentioned microphone positions ( 1 ) to ( 3 ) \text{:} 10 mm at the above \text{-} mentioned microphone positions ) . \\ This show that the path length difference is smaller than the path length difference b - d + e ( the diameter of the ear pad + the distance from the contact surface between the ear pad and the human body to the mic ( top of the housing ) ) when the one microphone is provided at the microphone position ( 3 ) .$$

Accordingly, it is found that the combination of the microphone positions (5) and (6) provides the effect regardless of the microphone installation positions as compared with when one microphone is provided.

As long as the housing and the ear pad have the same outer shape, the results at the microphone positions (4) to (6) in the above table do not change. This is because even if the outer shape is, for example, elliptical, f and d similarly vary irrespective of the directions of the longer diameter and the shorter diameter of the outer shape.

A non-hatched area and two hatched areas in FIG. 10 will be described.

When the amplitudes of noise and a canceling signal are assumed to be the same, an area for which a value derived from a calculation formula of sin(θ)+sin(θ+α) where the value θ varies (θ: an optional angle, a: phase difference between the noise and the canceling signal) is less than 0.5 corresponds to the non-hatched area.

An area for which the derived value is equal to or greater than 0.5 and less than 1 corresponds to an upper one of the two hatched areas, and an area for which the derived value is equal to or greater than 1 (amplification) corresponds to a lower one of the two hatched area.

It is recommended that the microphone be installed in a central portion of the cross section of a circular housing, because the microphone is located near the front of an entrance of the external auditory canal. Even when the microphone is offset, the value of sin(θ)+sin(θ+α) is smaller than 0.5 in a frequency range of up to around 1 kHz as long as the offset amount is smaller than 2.5 cm. Thus, the effect is provided.

2.

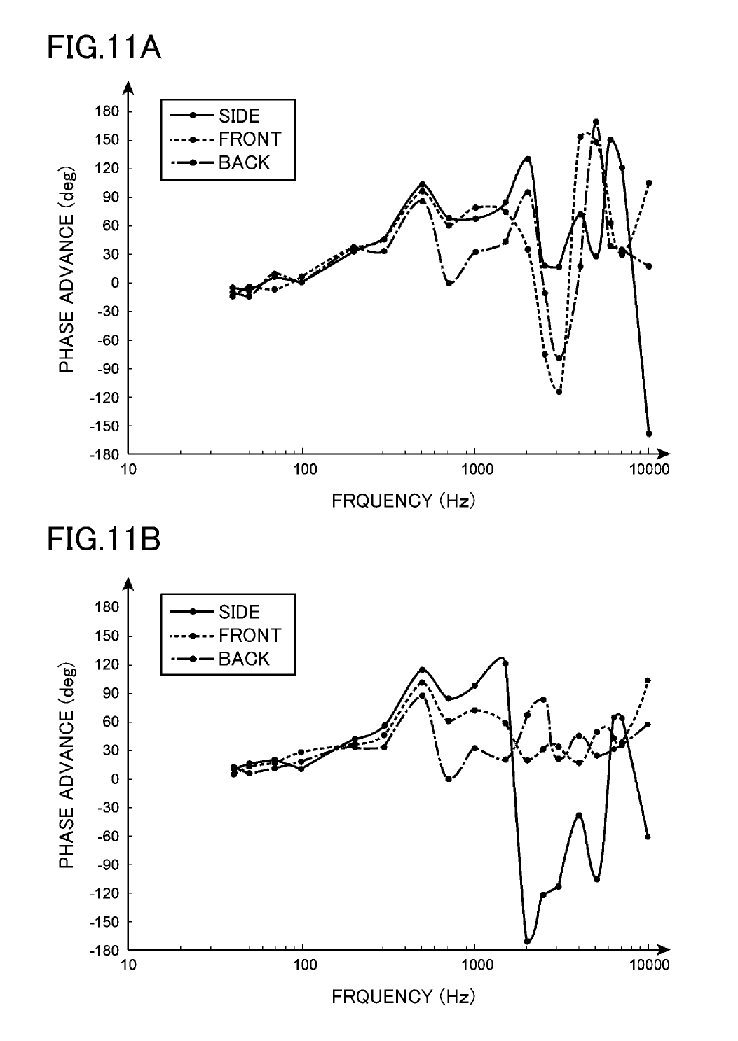

FIG. 11(a) is a graph showing results (phase characteristics for respective emission directions) of measurement of how signals that a microphone picks up vary with reference to noise reaching an eardrum if the noise is emitted from different directions and four ports illustrated in FIGS. 3 and 5 in the present invention are provided. FIG. 11(b) is a graph illustrating results (phase characteristics for respective emission directions) of measurement of how signals that the microphone picks up vary with reference to noise reaching the eardrum if the noise is emitted from different directions and the microphone is installed at a position (1) in FIG. 15 in a known example.

In FIGS. 11(a) and 11(b), a solid line indicates noise emitted from the side, a dashed line indicates noise emitted from the front, and a dashed-dotted line indicates noise emitted from the back.

In a frequency band of equal to or higher than 1 kHz, the phase differences as the measurement results among noises emitted from the three directions, i.e., the front, back, and side, are smaller in the present invention (FIG. 11(a)) than in the known example (FIG. 11(b)). Thus, the present invention (FIG. 11(a)) is more effective for exerting the noise-canceling effect to a higher frequency.

In the known example shown in FIG. 11(b), in a band in which the phase differences among the noises emitted from the directions and picked up by the microphone are large, a phase shift occurs to amplify the noise. Thus, a filter has its gain lowered, thereby preventing the filter from functioning.

3.

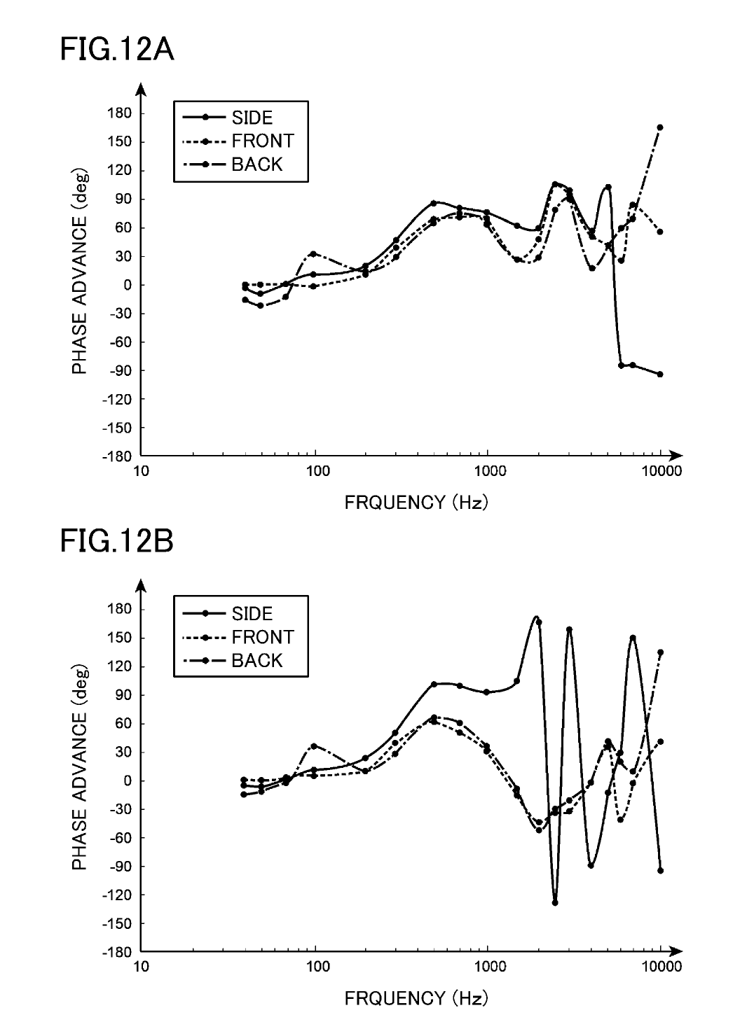

FIG. 12(a) is a graph showing results (phase characteristics for respective emission directions) of measurement of how signals that the microphone picks up vary with reference to noise reaching the eardrum if the noise is emitted from different directions and the microphone is omnidirectionally open as illustrated in FIG. 1 in the present invention. FIG. 12(b) is a graph illustrating the results (phase characteristics for the respective emission directions) of the measurement of how the signals that the microphone picks up vary with reference to the noise reaching the eardrum if the noise is emitted from different directions and the microphone is installed at the position (1) in FIG. 15 in the known example.

In FIGS. 12(a) and 12(b), a solid line indicates noise emitted from the side, a dashed line indicates noise emitted from the front, and a dashed-dotted line indicates noise emitted from the back.

In a frequency band of equal to or higher than 1 kHz, the phase differences as the measurement results among noises emitted from the three directions, i.e., the front, back, and side, are smaller in the present invention (FIG. 12(a)) than in the known example (FIG. 12(b)). Thus, the present invention (FIG. 12(a)) is more effective for exerting the noise-canceling effect to a higher frequency.

In the known example shown in FIG. 12(b), in a band in which the phase differences among the noises emitted from the directions and picked up by the microphone are large, a phase shift occurs to amplify the noise. Thus, a filter has its gain lowered, thereby preventing the filter from functioning.

4.

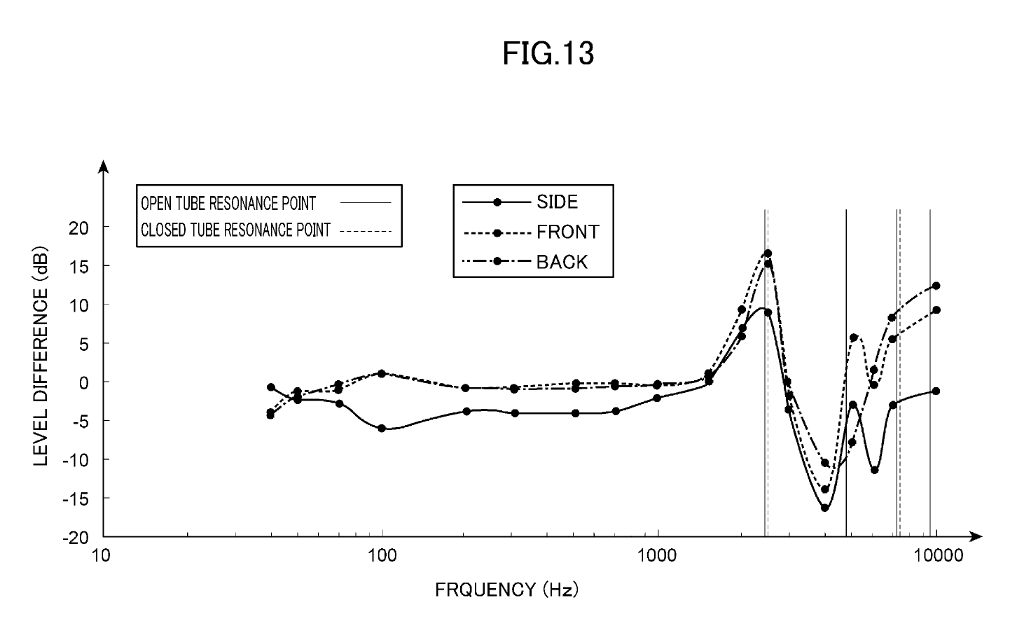

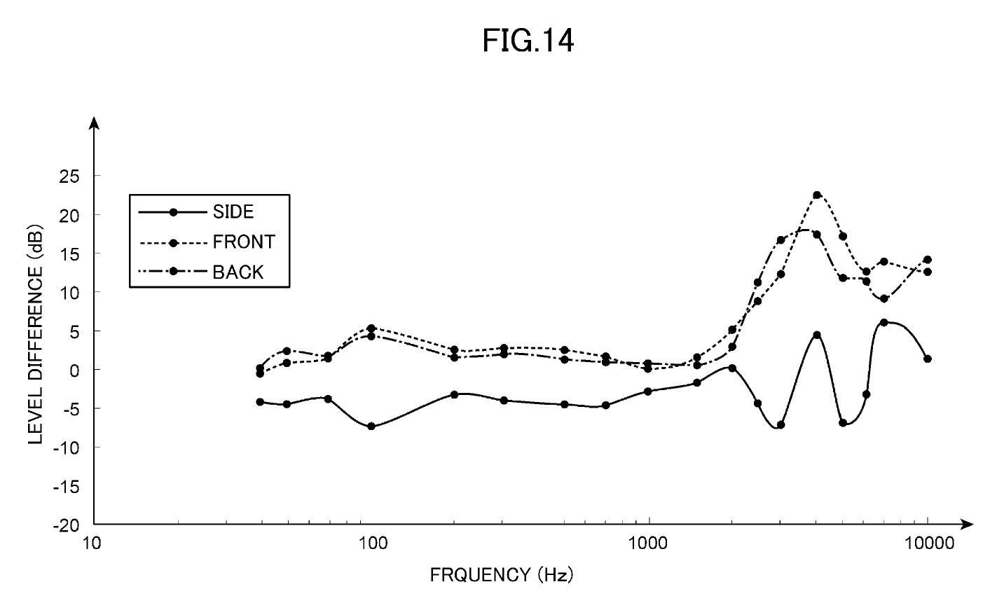

FIG. 13 is a graph showing the level difference of the microphone installed in the four ports illustrated in FIGS. 3 and 5 relative to the microphone installed outside the housing illustrated in FIG. 15 in the known example. FIG. 14 is a graph showing the level difference of the microphone installed in a slit having an opening circumferentially formed on the entire perimeter of the side surface of the housing 12 illustrated in FIG. 1 relative to the microphone installed outside the housing illustrated in FIG. 15 in the known example.

As shown in FIG. 12, signals that the microphone picks up have resonance points in the case of the configuration with the four ports. In the case of the noise emissions from the front and back, the tubes are supposed to be open tubes, and the resonance points of the open tubes are (1/2)λ, (2/2)λ, (3/2)λ, . . . , that is, 2.4 kHz, 4.9 kHz, 7.2 kHz, 9.7 kHz, . . . . In the case of the noise emission from the side, the tubes are supposed to be closed tubes, and the resonance points of the closed tubes are (1/4)λ, (2/4)λ, (3/4)λ, . . . , that is, 2.4 kHz, 7.3 kHz, 12 kHz, . . . .

As illustrated in FIG. 13, it is found that resonance is reduced in the presence of the slit with the opening over the entire circumference as illustrated in FIG. 1.

The configuration with the slit having the opening over the entire circumference in FIG. 1 makes it easier to design a filter than the configuration with the four ports in FIGS. 3 and 5.

It should be noted that even with the configuration with the four ports, the resonance does not occur if the port length is shorter than the port length causing the resonance.

### DESCRIPTION OF REFERENCE CHARACTERS

12 Housing
13 Speaker
16 Microphone
19 Guide

1. A noise-canceling headphone comprising
a housing including a microphone collecting external noise and a speaker emitting a sound toward an opening of an external auditory canal of a user, the noise-canceling headphone generating a noise-canceling signal from a noise signal collected by the microphone, driving the speaker with the noise-canceling signal, and emitting a noise-canceling sound having a phase opposite to that of the external noise, wherein
one microphone is provided outside a back cavity that is an acoustic space behind a diaphragm of the speaker in the housing, and
a guide guiding the external noise to the microphone is provided in the housing.

2. The noise-canceling headphone of claim 1, wherein
the guide is a slit circumferentially formed on a side surface of the housing extending along a traveling direction of the sound that is emitted from the speaker.

3. The noise-canceling headphone of claim 1, wherein
the guide includes:
a plurality of noise collection holes formed in a side surface of the housing extending along a traveling direction of the sound that is emitted from the speaker; and
tubes guiding external noise from the respective sound collection holes to the microphone.

4. The noise-canceling headphone of claim 1, wherein
the microphone is provided in a central portion of a cross section of the housing in a direction orthogonal to a traveling direction of the sound that is emitted from the speaker.

5. The noise-canceling headphone of claim 1, wherein
the microphone is provided at a position offset, by 2.5 mm or less, from a central portion of a cross section of the housing in a direction orthogonal to a traveling direction of the sound that is emitted from the speaker.
